(19) United States
(12) Patent Application Publication
(10) Pub. No.: US 2026/0290135 A1
(43) Pub. Date: Sep. 24, 2026

(54) METHOD AND DEVICE FOR VIRTUAL ACCESS CONTROL USING IMAGE ANALYSIS

(71) Applicant: HANWHA VISION CO., LTD., Seongnam-si (KR)

(72) Inventor: Jeff M. SWEENEY, Carlsbad, CA (US)

(73) Assignee: HANWHA VISION CO., LTD., Seongnam-si (KR)

(21) Appl. No.: 19/082,847

(22) Filed: Mar. 18, 2025

(51) Int. Cl. G08B 13/196; G06T 11/60; G06V 10/74; G06V 20/52; G06V 40/16; H04N 7/18

(52) U.S. Cl. CPC G08B 13/196; G06T 11/60; G06V 10/74; G06V 20/52; G06V 40/172; H04N 7/183

(57) ABSTRACT

A virtual access control method through image analysis is provided. The method may analyze a video image of individuals or objects approaching specific areas such as buildings. Personal information of objects authorized to access the specific area is pre-stored in a database. By comparing the data stored in the database with results of image analysis, identification probabilities may be determined for the identification variables of the objects, and corresponding identification results may be provided.

### BACKGROUND

### 1. Field

One or more example embodiments of the present disclosure relate to computer vision and image analysis technology, and more particularly, to a method and a device for controlling access to a specific area by using image information and data.

### 2. Description of Related Art

Related art access control systems are typically based on, for example, face recognition, fingerprint recognition, password entry, or physical authentication devices. Although these systems may offer high security, there are challenges such as increased authentication failure rates in certain situations (e.g., light reflection, low image quality, or long distances).

Additionally, related art access control systems operate only in limited zones, such as within buildings or at entry points, making it difficult to detect external access or potential threats in advance. To address these limitations, there is an increasing need for technologies that combine multiple data sources to provide object identification probabilities and expand the security coverage.

### SUMMARY

To solve the aforementioned problems, one or more example embodiments of the present disclosure provide a virtual access control method and a virtual access control device through image analysis, which may integrate multi-source data to identify objects with high reliability even in situations where authentication using face recognition or biometric information is challenging, thereby expanding a security perimeter.

Additionally, one or more example embodiments of the present disclosure provide a virtual access control method and a virtual access control device through image analysis that may obtain an identification probability of an object in real time and visualize a result of the image analysis through video overlay, enabling security administrators to focus on a potential threat and efficiently manage resources.

Objects of the present disclosure are not limited to the aforementioned objects, and other objects not mentioned may be clearly understood by those skilled in the art from the detailed description of the present disclosure.

According to an aspect of an example embodiment, provided is a virtual access control method for controlling an access to a specific area, including: obtaining an image capturing an object approaching the specific area; analyzing the image to extract a plurality of identification variables; determining an identification probability of the object for each of the extracted plurality of identification variables by comparing the extracted plurality of identification variables with personal information, stored in a database, of objects authorized to access the specific area; and providing an identification result of the object based on the identification probability.

The analyzing the image to extract the plurality of identification variables may be performed based on a determination that object recognition is not possible using at least one of face recognition or biometric recognition via the obtained image.

The obtaining the image may include obtaining the image using a camera installed in the specific area, which is regularly or periodically accessed by the objects authorized to access the specific area.

The determining the identification probability may include applying different weights to different identification variables; and determining the identification probability based on the weights.

The virtual access control method may further include: obtaining a first object identification result based on the determined identification probability as the object approaches the specific area, and obtaining a second object identification result based on at least one of facial recognition or biometric information recognition as the object further approaches the specific area; and adaptively adjusting weights of identification variables to be applied in a next first object identification result, based on comparison between the first object identification result and the second object identification result.

The plurality of identification variables may include one or more of facial recognition information, vehicle information, a physical characteristic, a gait pattern, and schedule information.

The determining the identification probability may include: sequentially comparing each of the plurality of identification variables with the personal information stored in the database; and determining a probability score for each of the plurality of identification variables, wherein the probability score of each identification variable dynamically changes as the object approaches the specific area.

The identification result may include one or more of identification information of the object, a probability score indicating a likelihood of the object being identified, and affiliation information of the object with the specific area.

The virtual access control method may further include: controlling to output a warning alarm, based on the probability score indicating the likelihood of the object being identified is below a predetermined threshold.

The virtual access control method may further include: controlling the obtained image to be displayed on a display of an image management device, and overlaying, on the displayed image, the identification probability determined for the plurality of identification variables and the identification result of the object.

According to an aspect of an example embodiment, provided is a virtual access control device using image analysis, including: a memory in which at least one program is recorded; and at least one processor configured to execute the at least one program, wherein the at least one program when executed by the at least one processor is configured to cause the at least one processor to: receive an image capturing an object approaching a specific area and analyze the image to extract a plurality of identification variables; determine an identification probability of the object for each of the extracted plurality of identification variables by comparing the extracted plurality of identification variables with personal information, stored in a database, of objects authorized to access the specific area; and provide an identification result of the object based on the identification probability.

The at least one processor may be caused to perform analyzing the image to extract the plurality of identification variables based on a determination that object recognition through at least one of facial recognition or biometric information recognition is not possible via the obtained image.

The at least one processor may be caused to obtain the image using a camera installed in the specific area, which is regularly or periodically accessed by the objects authorized to access the specific area.

The at least one processor may be further caused to: sequentially compare each of the plurality of identification variables with the personal information stored in the database; and determine a probability score for each of the plurality of identification variables, wherein the probability score of each identification variable dynamically changes as the object approaches the specific area.

The at least one processor may be further caused to determine the identification probability by applying different weights to different identification variables, and determining the identification probability based on the weights.

The at least one program may be further configured to cause the at least one processor to: obtain a first object identification result based on the determined identification probability as the object approaches the specific area, and obtain a second object identification result based on at least one of facial recognition or biometric information recognition as the object further approaches the specific area; and adaptively adjust weights of identification variables to be applied in a next first object identification result, based on comparison between the first object identification result and the second object identification result.

The plurality of identification variables may include one or more of facial recognition information, vehicle information, a physical characteristic, a gait pattern, and schedule information.

The identification result may include one or more of identification information of the object, a probability score indicating a likelihood of the object being identified, and affiliation information of the object with the specific area.

The at least one program may be further configured to cause the at least one processor to: control to output a warning alarm, based on the probability score indicating the likelihood of the object being identified is below a predetermined threshold.

The at least one program may be further configured to cause the at least one processor to: control the obtained image to be displayed on a display of an image management device, and overlay, on the displayed image, the identification probability determined for the plurality of identification variables and the identification result of the object.

### BRIEF DESCRIPTION OF DRAWINGS

The accompanying drawings, which are included to provide a further understanding of the present disclosure and constitute a part of the detailed description, illustrate one or more example embodiments of the present disclosure and serve to explain technical features of the present disclosure together with the description.

FIG. 1 is a diagram explaining a general method for controlling access to a specific area.

FIG. 2 is a schematic diagram showing a surveillance camera system according to an embodiment of the present disclosure.

FIG. 3 is a schematic block diagram of an image processing device according to an embodiment of the present disclosure.

FIG. 4 is an example of a system for implementing a virtual access control method through image analysis according to an embodiment of the present disclosure.

FIG. 5 is a flowchart of a virtual access control method through image analysis according to an embodiment of the present disclosure.

FIGS. 6A to 7 illustrate examples of identification probabilities being overlaid and displayed on a display of an image management device according to a virtual access control method through image analysis according to one or more embodiments of the present disclosure.

FIG. 8 shows an example of utilizing a security system that applies identification probabilities determined for multiple objects according to an embodiment of the present disclosure.

FIG. 9 is a flowchart of a virtual access control method through image analysis according to another embodiment of the present disclosure.

FIGS. 10 to 12 illustrate examples of video overlays showing real-time changes in object identification probabilities according to one or more embodiments of the present disclosure.

FIG. 13 is a flowchart of a virtual access control method through image analysis according to another embodiment of the present disclosure.

FIG. 14 illustrates an example of narrowing down the identification targets among multiple objects based on identification probabilities according to an embodiment of the present disclosure.

### DETAILED DESCRIPTION

Hereinafter, one or more example embodiments disclosed in the present disclosure will be described in detail with reference to the accompanying drawings. Identical or similar components may be assigned the same reference numerals, regardless of their depiction in the drawings, and redundant descriptions will be omitted. The suffixes “module” and “unit” used for components in the following description are provided solely for the convenience of writing this specification and do not indicate any distinct meanings or functions by themselves.

Moreover, detailed descriptions of well-known techniques will be omitted when it is determined that they could obscure the gist of the embodiments disclosed herein. The attached drawings are provided to aid in the understanding of the disclosed embodiments and do not limit the technical ideas disclosed herein. The technical scope of the present disclosure should be interpreted as including all modifications, equivalents, and substitutions within the spirit of the present disclosure.

Terms including ordinals such as “first” and “second” may be used to describe various components, but the components should not be limited by these terms. These terms are used only to distinguish one component from another.

When an element is referred to as being “connected to” or “coupled to” another element, it may be directly connected or coupled to the other element, or intervening elements may be present. In contrast, when an element is referred to as being “directly connected to” or “directly coupled to” another element, there are no intervening elements.

Unless otherwise clearly indicated by the context, the singular forms used herein include plural forms as well.

In the embodiments of the present disclosure, terms such as “comprises” or “includes” specify the presence of features, numbers, steps, operations, components, parts, or combinations thereof described in the specification, and do not preclude the presence or addition of one or more other features, numbers, steps, operations, components, parts, or combinations thereof.

Moreover, in the embodiments of the present disclosure, “at least one” among a plurality of components may refer to any combination, including all components, any individual component, or any subset of components.

The phrase “configured to” may, depending on the context, be used interchangeably with phrases such as “suitable for,” “having the capacity to,” “designed to,” “adapted to,” “made to,” or “capable of.” The phrase “configured to” does not necessarily mean a component specifically designed in hardware. For example, the phrase “a processor configured to perform A, B, and C” may include a dedicated processor designed to execute such tasks (e.g., an embedded processor) or a general-purpose processor (e.g., a central processing unit (CPU) or application processor) capable of performing such tasks through the execution of one or more software programs stored in a memory device.

In this specification, the term “image” may encompass various forms, including a video, a still image, and a non-continuous video format such as Motion Joint Photographic Experts Group (MJPEG).

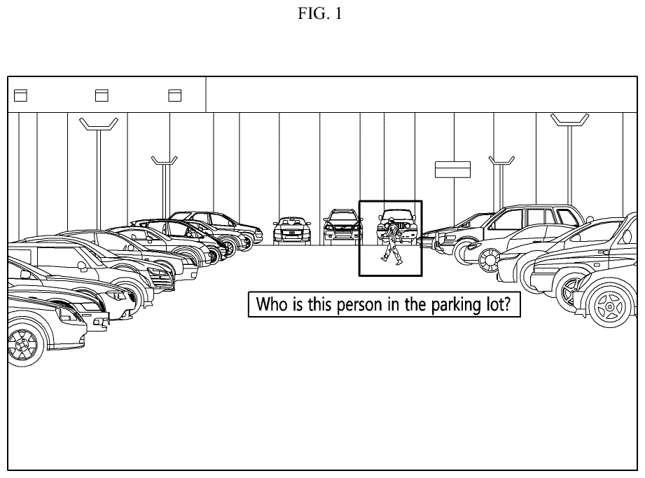

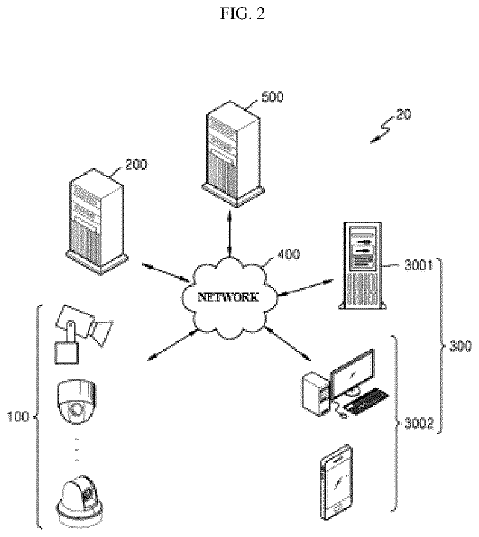

FIG. 1 is a diagram illustrating a general method for controlling access to a specific area based on an access control system. Referring to FIG. 1, a main entrance of a building may be equipped with entrance cameras and biometric authentication devices (e.g., facial recognition, fingerprint scanners) to determine whether an authorized user is attempting to access the building. Devices such as Radio Frequency Identification (RFID) card readers or password input devices may be used to verify an identity of an employee or a visitor. Pre-registered user information (e.g., facial images, fingerprints, badge information) may be stored and compared with input information to determine an access approval.

Related art access control systems operate security functions only within the building or at its entrances, making it difficult to identify objects or detect risks in advance when the objects are in external areas such as parking lots or outdoor zones. Since the related art systems typically rely on a single data source, such as a badge card, facial recognition, or fingerprint recognition, issues like improper camera angles, poor image quality, or device malfunctions may lead to identification failures. Furthermore, if incorrect authentication occurs, administrators must verify the situation on-site, creating limitations for real-time alerts and risk management.

Accordingly, in an embodiment of the present disclosure, to expand a security perimeter within a certain range from the building, a virtual access control method and device through image analysis are provided. In the following description, it is assumed that the virtual access control method and device are implemented in an environment of a surveillance camera system.

FIG. 2 is a schematic diagram illustrating a surveillance camera system according to an embodiment.

Referring to FIG. 2, a surveillance camera system 20 according to an embodiment may include an image processing device 100 and an external device 300. In an embodiment, the surveillance camera system 20 may further include a network server 200 capable of wired or wireless communication with the image processing device 100 and the external device 300.

The image processing device 100 may be an electronic device for capturing a monitored area and obtaining a video and an audio from the monitored area. The image processing device 100 may capture the monitored area in real time for surveillance or security purposes and may include one or more components. The image processing device 100 may include a fixed-position camera installed at a specific location, a camera that may move automatically or manually along a set path, and/or a camera that may be moved by a person or robot. The image processing device 100 may include a PTZ (Pan-Tilt-Zoom) camera with pan, tilt, and zoom functions. The image processing device 100 may include an analog camera and/or an Internet protocol (IP) or network camera connected via wired or wireless internet. Depending on the camera's functionality and purpose, the image processing device 100 may take various forms and sizes, such as dome-shaped, box-shaped, bullet-shaped, or camouflaged types.

In an embodiment, the image processing device 100 may be a visible light camera that acquires image information by detecting light and generates a visible image based on the luminance distribution of objects. In another embodiment, the image processing device 100 may be an infrared camera (or thermal imaging camera) that detects thermal energy emitted by objects as infrared wavelengths, a type of an electromagnetic wave. The image processing device 100 may measure an intensity of thermal energy and generate a thermal image where different colors represent varying intensities.

The image processing device 100 may have functions to record a video or take photos of the monitored area. The image processing device 100 may also have functions to record sounds occurring in the monitored area. The image processing device 100 may generate alerts and/or initiate recording and/or photo capture when a change, such as a movement or a sound, is detected in the monitored area.

The image processing device 100 may analyze the captured video itself or the video obtained after editing. For example, the image processing device 100 may use an object detection algorithm to detect an object within the video. The object detection algorithm may apply artificial intelligence (AI)-based techniques, using a pre-trained artificial neural network model(s) to detect an object.

The image processing device 100 may analyze the video and generate metadata along with index information for the metadata. The image processing device 100 may analyze an audio included in the video, either jointly or separately, to generate metadata and corresponding index information.

The network server 200 may provide various functionalities to the image processing device 100 and the external device 300 through the network 400. In FIG. 2, the network server 200 is depicted as a standalone component separate from the image processing device 100, but the embodiments of the present disclosure are not limited to this configuration. For example, the network server 200 may be embedded within the image processing device 100. A detailed description of the network server 200 will be provided later.

The external device 300 may include a server 3001 and a client 3002.

The server 3001 may include devices such as a Digital Video Recorder (DVR), a Network Video Recorder (NVR), or a Video Management System (VMS) and provide functions such as video storage, retrieval, and/or management. The server 3001 may receive a video and/or an audio from the image processing device 100, store the video and/or the audio, and index the video and/or the audio for user searches. The server 3001 may also analyze the video and/or the audio received from the image processing device 100. In an embodiment, multiple servers 3001, which are physically located in different places, may be federated and managed under a single software system.

The client 3002 may be a terminal that includes devices such as a desktop PC, a tablet PC, a slate PC, a notebook computer, or mobile devices such as smartphones. The client 3002 may have software and/or applications installed for video monitoring and retrieval by a user (operator). In an embodiment, the client 3002 may be installed in, for example, public institutions, police stations, hospitals, central control rooms, central monitoring centers, or comprehensive situation rooms. The client 3002 may be connected to the image processing device 100 and/or the server 3001 through a network. In an embodiment, the client 3002 may manage and operate the image processing device 100 and the server 3001 based on a cloud system.

In an embodiment, the client 3002 may send a data provision request signal to the image processing device 100 or the server 3001, requesting provision of all or part of the video and/or the audio. The client 3002 may then receive all or part of the video and/or the audio from the image processing device 100 or the server 3001. The client 3002 may also send a data provision request signal to the image processing device 100 or the server 3001, requesting metadata and/or index information obtained by analyzing the video and/or the audio, and may receive the requested metadata and/or index information.

The image processing device 100, the network server 200, and the external device 300 may communicate via wired or wireless communication through the network 400. The network 400 may include wired networks such as Local Area Networks (LANs), Wide Area Networks (WANs), Metropolitan Area Networks (MANs), and Integrated Service Digital Networks (ISDNs). It may also include wireless internet networks such as 3G, 4G (LTE), 5G, WiFi, Wireless Broadband (WiBro), WiMAX, wireless LANs, and code division multiple access (CDMA). Additionally, it may include wireless communication technologies such as satellite communication, Bluetooth, Radio Frequency Identification (RFID), Infrared Data Association (IrDA), Ultra Wideband (UWB), ZigBee, and Near Field Communication (NFC). In the case of wireless mobile communication, the network 400 may further include components such as a Base Transceiver Station (BTS), a Mobile Switching Center (MSC), a Home Location Register (HLR), an Access Gateway for transmitting and receiving wireless packet data, and a Packet Data Serving Node (PDSN). The scope of the present disclosure is not limited to these configurations.

The video analysis server 500 may be a device that receives and stores the video itself, which is captured through the image processing device 100, and/or the video obtained through editing. The video analysis server 500 may perform video and/or audio analysis functions of the image processing device 100. For example, the video analysis server 500 may analyze a video and/or an audio received in real time from the image processing device 100 or analyze stored video according to its intended use. The video analysis server 500 may analyze the video to generate metadata and corresponding index information. The video analysis server 500 may also analyze an audio contained in the video either jointly or separately to generate metadata and corresponding index information. The video analysis server 500 may be an AI server implementing artificial intelligence-based video analysis functions.

The external device 300 may send a data provision request signal to the video analysis server 500 to request provision of all or part of the video and/or the audio. The external device 300 may also send a request signal to the video analysis server 500 for metadata and/or index information obtained by analyzing the video and/or the audio.

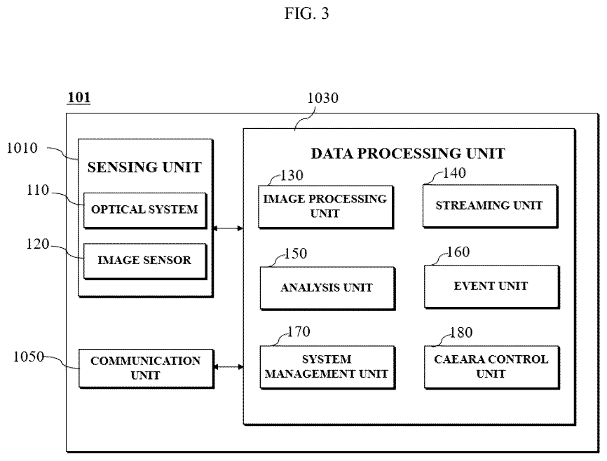

FIG. 3 shows schematic block diagrams of the image processing device according to an embodiment.

In an embodiment, the image processing device 100 may include a camera 101. The camera 101 may be an IP camera or a network camera. The camera 101 may capture images, compress the captured images, and transmit the compressed images to the external device 300 (refer to FIG. 2) using a predetermined transmission protocol. For example, the camera 101 may capture images, analyze the captured images in real time to detect, identify, track, analyze a behavior of, and search for a target and/or a moving object, and provide appropriate information or functions to the user.

The camera 101 may include a sensing unit 1010, a data processing unit 1030, and a communication unit 1050.

The sensing Unit 1010 may be a detection means that includes an optical system 110 and an image sensor 120.

The optical System 110 may optically process light from a subject. The optical System 110 may include at least one lens, such as a zoom lens for controlling a field of view according to a focal length and a focus lens for focusing. In an embodiment, the lens may include at least one glass lens and/or at least one liquid lens. The liquid lens may adjust its shape (curvature) using a fluid to control zoom and focus. The liquid lens may have advantages such as reducing a number and a size of lenses and quickly achieving a desired focal length.

The optical system 110 may further include an optical low-pass filter (OLPF), an infrared cut filter (IRCF), and/or an iris for controlling light intensity.

The image sensor 120 may capture images of the monitored area. In an embodiment, the image sensor 120 may be implemented using a Charge-Coupled Device (CCD) sensor or a Complementary Metal-Oxide-Semiconductor (CMOS) sensor. The image sensor 120 may convert optical signals transmitted through the optical system 110 into electrical signals.

The data processing unit 1030 may be an information processing means implemented with various hardware and/or software configurations to execute specific functions. For example, the data processing unit 1030 may represent a hardware-embedded data processing device structured to execute functions expressed in the form of codes or commands included in a program. The hardware-embedded data processing device may encompass devices such as a microprocessor, a central processing unit (CPU), an image signal processor (ISP), a processor core, a multiprocessor, an application-specific integrated circuit (ASIC), a field-programmable gate array (FPGA), and others, but the scope of the present disclosure is not limited thereto.

In an embodiment, the data processing unit 1030 may include a neural processing unit (NPU). The NPU may be integrated into the aforementioned processing unit or processor. The NPU may be a processor specialized for processing an artificial intelligence model(s), which may be created through machine learning. The AI model may include multiple layers of artificial neural networks, such as deep neural networks (DNNs), convolutional neural networks (CNNs), recurrent neural networks (RNNs), restricted Boltzmann machines (RBMs), deep belief networks (DBNs), and others.

The AI model may be trained by collecting and labeling appropriate training data for tasks such as object detection, classification, and/or recognition. The trained AI model may be embedded in the camera 101 and used for inference operations, including object detection, classification, and/or recognition, through the neural processing unit or the aforementioned data processing devices.

In an embodiment, after the AI model is deployed in the camera 101, the AI model may undergo additional training via a cloud server to adapt to a monitoring environment and/or user requirements. The newly trained model may be redistributed to the camera 101.

The image processing unit 130 may improve image quality by adjusting parameters such as brightness, contrast, color, and/or sharpness. The image processing unit 130 may perform image signal processing for noise reduction, gamma correction, color correction, and/or edge enhancement.

The streaming unit 140 may compress the video received from the image processing unit 130 and provide the compressed video to external devices through the network.

The analysis unit 150 may analyze the video processed by the image processing unit 130 in real time. The analysis unit 150 may perform background detection, foreground and object detection, object counting, camera tampering detection, and/or face detection.

The analysis unit 150 may detect motion using motion detection algorithms and distinguish between vocal and non-vocal audios using an artificial neural network(s).

The event unit 160 may receive metadata from the analysis unit 150 and detect events based on the metadata. The event unit 160 may trigger an action, such as an alarm, when a specific event occurs.

The system management unit 170 may manage firmware updates and product information, as well as provide power to various components of the camera.

The camera control unit 180 may control the camera's position and orientation based on motion information, user inputs, or preset configurations.

The communication unit 1050 may be an interface that enables wired or wireless communication with the network server 200 and the external devices 300. The communication unit 1050 may transmit streams using protocols such as TCP/IP, HTTPS, RTP/RTSP, FTP, and MQTT.

Only components related to the present embodiment are depicted to prevent the features of the present embodiment from being obscured. Therefore, it will be understood by those skilled in the relevant technical field that additional general-purpose components may be included beyond those shown in FIG. 3.

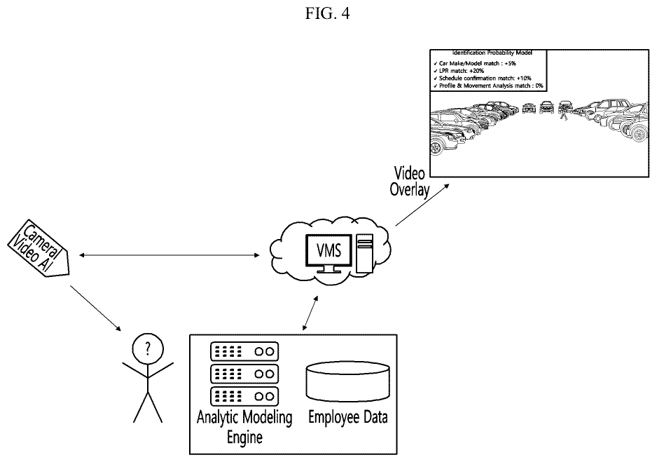

FIG. 4 is an example of a system for implementing a virtual access control method through image analysis according to an embodiment of the present disclosure.

Referring to FIG. 4, the system for implementing the virtual access control method through image analysis according to an embodiment of the present disclosure may include a camera module (or image input device), an image analysis device (e.g., VMS), and a database. The camera module may correspond to the image processing device 100 and the camera device 101 described in FIGS. 2 and 3, and the image analysis device (VMS) may correspond to the video analysis server 500 described in FIG. 2.

### Camera Module (Image Input Device)

The image input device (or camera module) may be installed at key locations in the building, such as parking lots, hallways, and entrances, to collect a real-time video. The camera may detect movements of vehicles, people, and objects and transmit initial data to the image analysis device (VMS). The image analysis device (VMS) may detect and analyze objects (such as vehicles or people) based on the input video and calculate an object identification probability using various identification variables, such as license plate recognition (LPR), physical characteristics (e.g., height, body shape, gait), and/or facial recognition.

### Database

The database may be a device for storing identification information, where pre-stored employee data (e.g., vehicle information, work schedules, facial images, and/or physical data) may be compared with real-time collected data. The database may include weight information for each identification variable, which may be used in the calculation of identification probabilities.

### Probability Model Engine

In an embodiment, a probability model engine may be used to calculate object identification probabilities. Based on the data received from the image analysis device (VMS), the probability model engine may calculate the identification probability of each object. Initially, the identification probability of an object may have a low value, such as using basic information like vehicle data. However, as additional information, such as physical characteristics and movement patterns, accumulates over time, the value of the identification probability may gradually increase.

### Video Overlay Interface

In an embodiment, a video overlay interface may visually display real-time information, including object identification probabilities, current status, and potential risk information, on a screen. For example, if the initial identification probability is 5% based on vehicle information alone, the identification probability may dynamically increase to 55% as a person exits the vehicle and matching physical characteristics and gait patterns are detected. This dynamic process may be reflected in the real-time information displayed through the video overlay interface.

### Integration With Existing Access Control Systems

In an embodiment, the present disclosure may be integrated with existing access control systems. When an object further approaches or reaches a building entrance, the present disclosure may automatically interlink with existing access control system(s) (e.g., badge scanning, facial recognition systems) to verify final identification. Once verification is completed, the system according to the present disclosure may adaptively adjust weights of variables in the probability model based on the identification results to improve an accuracy of future identification. For example, a first object identification result (or initial object identification result) may be obtained based on the determined identification probability as the object approaches the specific area, and a second object identification result (or updated object identification result) may be obtained based on at least one of facial recognition or biometric information recognition as the object further approaches or reaches the specific area, and weights of identification variables may be adaptively adjusted to be applied in a next first object identification result, based on comparison between the first object identification result and the second object identification result.

In an embodiment, if the identification probability has a low value or the object is classified as a potential risk, the system may send a warning alert to the administrator. For example, unidentified vehicles or objects appearing at unexpected times may trigger risk alerts, prompting additional measures to be taken.

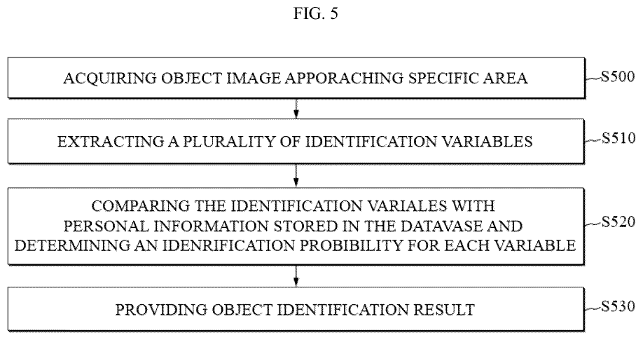

FIG. 5 is a flowchart of a virtual access control method through image analysis according to an embodiment of the present disclosure. The virtual access control method may be implemented via the video analysis server 500 (VMS) depicted in FIG. 2 or, if the functions of the video analysis server 500 are embedded in the image processing device 100 (camera), the virtual access control method may be implemented through the image processing device 100. Additionally, the method may be implemented through a combination of the video analysis server 500 and the image processing device 100. For ease of explanation, it is assumed that the operations of the access control method of FIG. 5 are controlled through a processor (not shown) of the video analysis server 500.

The processor may acquire an image of an object approaching the specific area (S500). The object image may be captured through a camera device installed around the specific area to monitor a surrounding area. The specific area may include buildings or locations that are regularly or periodically accessed by authorized users (e.g., employees). Therefore, the specific area may refer to the building itself, including its interior or entrance. The surrounding area of the specific area may refer to external areas of the building, with a security boundary extending a predetermined distance from the building entrance using the camera device. In an embodiment, this predetermined distance may include parking areas where vehicles entering the building or attempting to enter the building are recognized through the building's parking system.

Objects entering the specific area may include employees, employers, members, patients, medical staff, students, professors, approved suppliers, and/or contractors with pre-assigned access permissions. The present disclosure may distinguish between objects that are authorized to access the specific area and those that are not based on an identification probability, and classify unauthorized objects as potential threats.

The processor may analyze the acquired image to extract a plurality of identification variables (S510). These variables may include, for example but not limited to, facial recognition information, vehicle information such as vehicle models and license plate numbers, physical characteristics, gait patterns, and/or schedule information. The identification variables may be managed by pre-registering and storing personal information of authorized individuals in a database.

If the processor determines that object recognition through at least one of facial recognition or biometric information recognition is not possible from the acquired image, the processor may extract the identification variables in S510. If facial or fingerprint recognition is possible, existing access control methods may accurately identify the object and determine access permissions. The present disclosure may improve security by supplementing existing access control methods when the object recognition from the acquired image is not possible.

The processor may compare the extracted identification variables with the personal information stored in the database and calculate an identification probability for each identification variable (S520). Each identification variable may have a different weight. For example, suppose a person recognized in a camera footage is an employee authorized to access the building. In this case, the employee's personal information (e.g., employee ID, registered vehicle, license plate number, and physical data such as height, body shape, and gait pattern) is stored in the database. Variables such as employee ID and vehicle information are highly reliable for identification, while physical characteristics such as a body shape and a gait pattern may have relatively lower reliability. Therefore, different weights may be applied based on the attributes and characteristics of each identification variable.

Based on the calculated identification probabilities, the processor may provide an object identification result (S530). This result may be determined by summing probabilities determined for each identification variable, using weighted sums, or applying a predefined rule(s) to determine a likelihood that the identified object has an access permission. A higher probability value may indicate a higher accuracy of object recognition, while a lower probability value may indicate a potential threat requiring additional management by security personnel.

The processor may control an overlay of the identification result on the video, displaying information such as the object's identification details, a probability score, and the object's affiliation with the specific area.

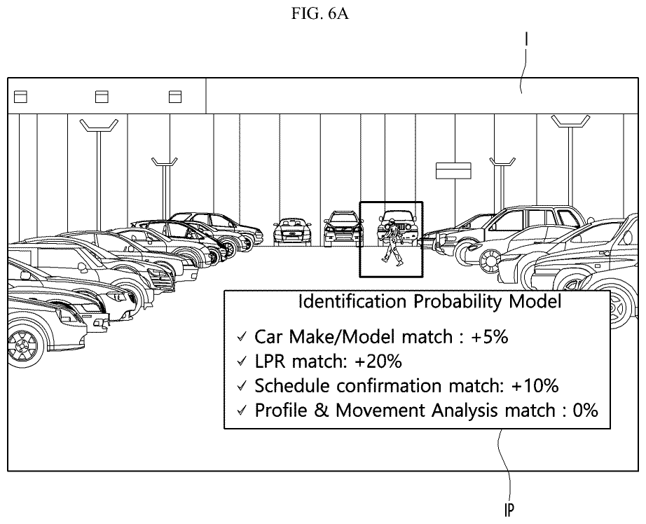

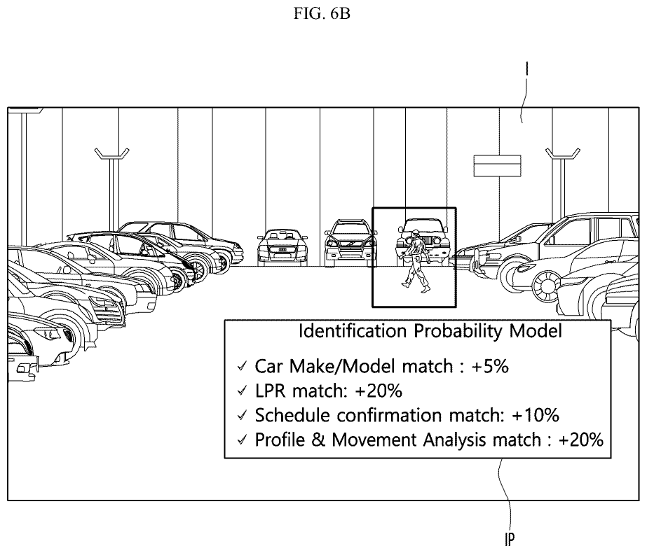

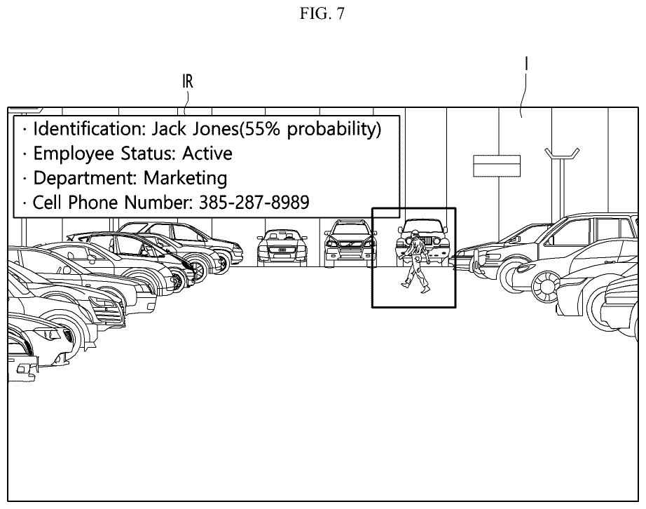

Hereinafter, FIGS. 6A to 7 provide a more detailed explanation of the virtual access control method through image analysis illustrated in FIG. 5.

FIGS. 6A to 7 illustrate examples of identification probabilities being overlaid and displayed on a screen of a video management device according to the virtual access control method through image analysis in one or more embodiments of the present disclosure. In FIGS. 6A to 7, the video management device configures an embodiment in which an acquired image (I) is displayed on a display, and an identification probability (IP) is dynamically changed as an object approaches a specific area and is overlaid on the display.

Referring to FIG. 6A, when an object (e.g., vehicle) enters the surveillance area in the parking lot or outside the building, the camera may detect identification variables such as vehicle information (e.g., Car Make and/or Model match) and the vehicle's license plate (LPR, License Plate Recognition). The processor may compare the detected vehicle information and license plate with the data stored in the database. If the identification variables match database records, the processor may determine an initial probability value indicating the likelihood that an owner of the vehicle is an object having an access permission.

Additionally, the processor may refer to the owner's work schedule information (schedule confirmation match) to determine whether it is a working day and if a current time aligns with an expected arrival time at a company. For example, the processor may determine a 5% identification probability to the vehicle information (Car Make/Model match), a 20% identification probability to the vehicle's license plate (LPR), and a 10% identification probability to the matching of the work schedule information. The identification probabilities determined for each identification variable may be determined based on the weights pre-assigned to those variables, which may vary depending on the environment in which the object is recognized. These weights may be adjusted by the user and/or administrator or designed to be automatically updated.

FIG. 6A illustrates an initial stage of probability calculation only based on vehicle information recognized by a vehicle entry recognition system, which may result in relatively low probability values.

In contrast, FIG. 6B depicts a scenario where the object (person) exits the vehicle, and the camera analyzes physical characteristics of the person (such as height and body shape) and compares the physical characteristic with the database records. Compared with an initial probability based on vehicle information (for example, a combined probability of 35% from a sum of the probabilities of the individual identification variables), the probability may increase as the physical characteristics are matched. An identification probability 20% may be determined for identification variables corresponding to profile and movement analysis.

Thus, as the recognition process progresses, the overall probability of correctly identifying the object may increase through the accumulation of additional identification variables.

Meanwhile, referring to FIG. 7, the processor may overlay and display the object identification result (IR) on the video based on the identification probability values determined for all the detected identification variables through the comparison of the camera footage with the database. For instance, the object identification result may indicate that the probability of the identified object being “Jack Jones” is 55%, and additional information, such as a department (Marketing) Jack Jones works in and the company's phone number, may be provided along with the object identification result.

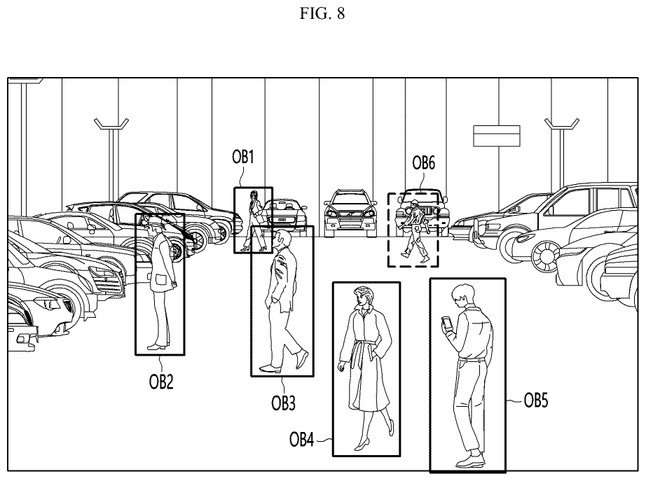

FIG. 8 illustrates an example of utilizing a security system by leveraging the identification probabilities determined for multiple objects according to an embodiment of the present disclosure.

Referring to FIG. 8, multiple objects (individuals: OB1, OB2, OB3, OB4, OB5, OB6) may be recognized in the parking lot or external areas of the building through a camera footage. Initial data such as vehicle numbers, physical characteristics, and/or gait patterns may be collected for each object to calculate their identification probabilities. The initially determined identification probabilities may be updated as the objects move toward the building.

Objects 1 to 5 may be recognized as objects (referred to as “normal objects”) with identification probabilities above a threshold (e.g., 50%), while Object 6 (OB6) may have an identification probability below the threshold. In this case, a bounding box around Object 6 (OB6) may be visually distinguished from those of the normal objects (OB1 to OB5). The processor may evaluate whether each object is safe based on the threshold and may activate an alert for Object 6 (OB6). The security administrator may classify the normal objects (OB1 to OB5) as safe individuals and focus additional verification efforts on Object 6 (OB6).

The normal objects (OB1 to OB5) may be allowed entry to the building, while the potentially risky Object 6 (OB6) may undergo further verification by the security administrator to confirm its identity. If Object 6 (OB6) attempts to enter the company building outside of its scheduled work time or uses an unregistered vehicle, which does not match the expected information stored in the database, access may be denied according to a security process.

Thus, according to an embodiment of the present disclosure, when multiple objects are recognized, objects with low identification probabilities, as determined by the threshold, may be classified as potential threats based on their identification probabilities.

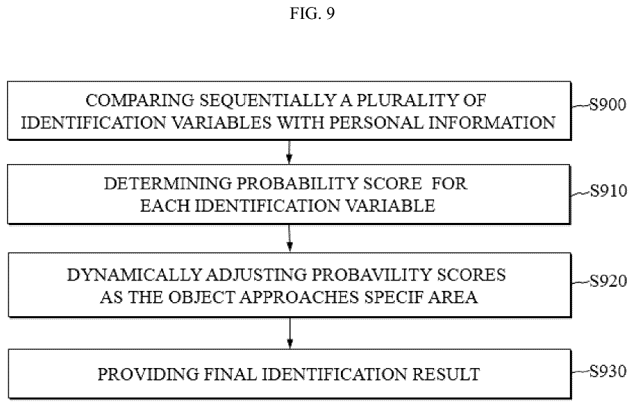

FIG. 9 is a flowchart of a virtual access control method through image analysis according to another embodiment of the present disclosure.

Referring to FIG. 9, the processor may sequentially compare each of the plurality of identification variables with personal information stored in the database (S900). In an embodiment, the processor may compare identification variables such as vehicle license plate numbers, physical characteristics (e.g., height and body shape), gait patterns, and facial recognition information collected via cameras and sensors with personal information stored in the database in a sequential manner according to predefined criteria. For example, the processor may first compare the recognized vehicle license plate with the vehicle information registered for employees in the database. Then, the processor may compare the recognized physical characteristics, such as height and body shape, with the registered personal data. Finally, the processor may recognize the object's motion pattern from the camera footage and compare the recognized motion pattern with the individual's gait pattern stored in the database.

The processor may determine a probability score for each identification variable (S910). For instance, if the vehicle license plate matches, a score of 20% may be determined. For matching physical characteristics (height), a score of 40% may be determined. Gait pattern analysis may result in a score of 70%, while matching with the work schedule may yield a score of 10%.

The processor may dynamically adjust the probability scores as the object approaches the specific area (S920). In an embodiment, the initial matching of the vehicle license plate and physical characteristics in the parking lot may result in probability scores ranging from 20% to 40%. As the object moves from the parking lot to the building entrance, the processor may add gait pattern matching data, which may increase the probability score to 55% to 70%. At the building entrance, as facial recognition is performed, the probability score may further increase to 70% to 95%. As the object gets closer to the building entrance, higher-confidence variables may be added, resulting in a gradual increase in identification reliability.

The processor may combine all identification variables to calculate the final probability and provide the object identification result, including relevant identity information (S930). As the probability score increases, the system may ensure higher accuracy and confidence in identifying the object, thereby improving overall security.

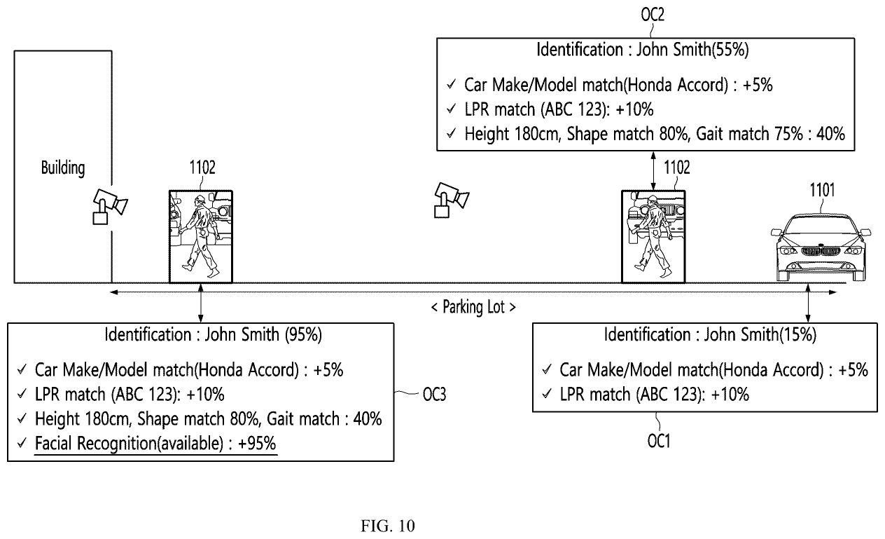

FIGS. 10 to 12 illustrate examples of video overlays showing real-time changes in object identification probabilities according to one or more embodiments of the present disclosure.

Referring to FIG. 10, in an initial stage (OC1), a vehicle (1101) entering the parking lot is identified as a Honda Accord with license plate ABC123. The processor may determine an initial identification probability based on vehicle information matching (5%) and license plate matching (10%), resulting in a combined initial identification probability of 15%, as only vehicle-related information is available at this stage. An initial object identification result of the initial stage (OC1) may be overlaid on the video. As the object moves toward the building entrance, the identification result may progress through OC2 and OC3.

In an intermediate stage (OC2), a person (1102) exits the vehicle and walks toward the building entrance. The processor may collect additional data, including physical characteristics (height: 180 cm, body shape matching 80%) and gait pattern matching (75%), which increases the identification probability. An intermediate identification probability indicates a 55% chance that the object is John Smith.

In a final stage (OC3), as facial recognition is performed at the building entrance, the facial recognition matching score of 95% is added. As a result, a probability that the object is John Smith increases to 95%, allowing normal access according to a confirmed identity based on a combination of the vehicle and the individual.

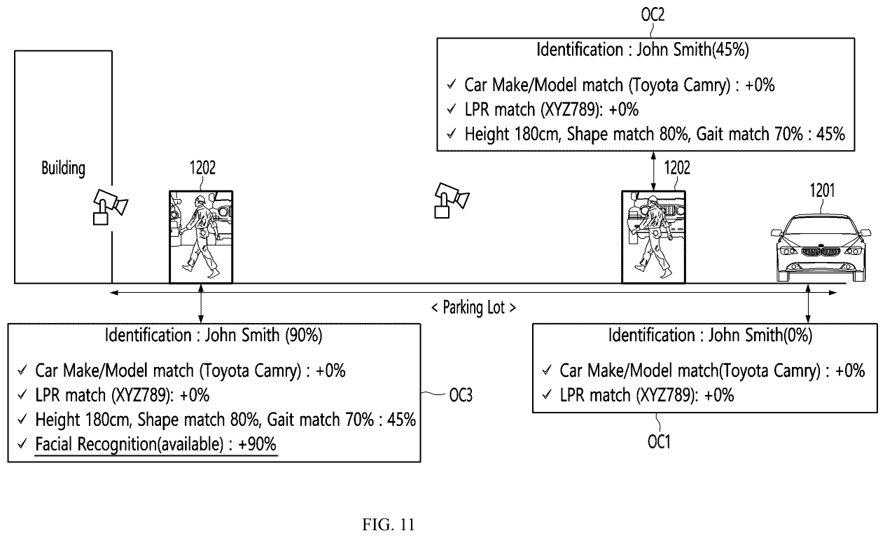

Referring to FIG. 11, in the initial stage (OC1), a vehicle (1201) detected is a Toyota Camry with license plate XYZ789. Since the vehicle is not associated with any personal information recorded in the database (e.g., John Smith), the initial vehicle information and license plate matching scores start at 0%.

In the intermediate stage (OC2), as a person (1202) exits the vehicle and walks toward the building entrance, the processor may analyze physical characteristics (height: 180 cm, body shape matching 80%) and gait pattern matching (70%), increasing the identification probability. At this stage, the probability that the object is John Smith is 45%.

In the final stage (OC3), as facial recognition is activated at the building entrance, a facial recognition match score of 90% is added, raising the probability that the object is John Smith to 90%. Although the vehicle information did not initially match, the combination of physical characteristics and facial recognition confirms John Smith's identity, allowing normal access.

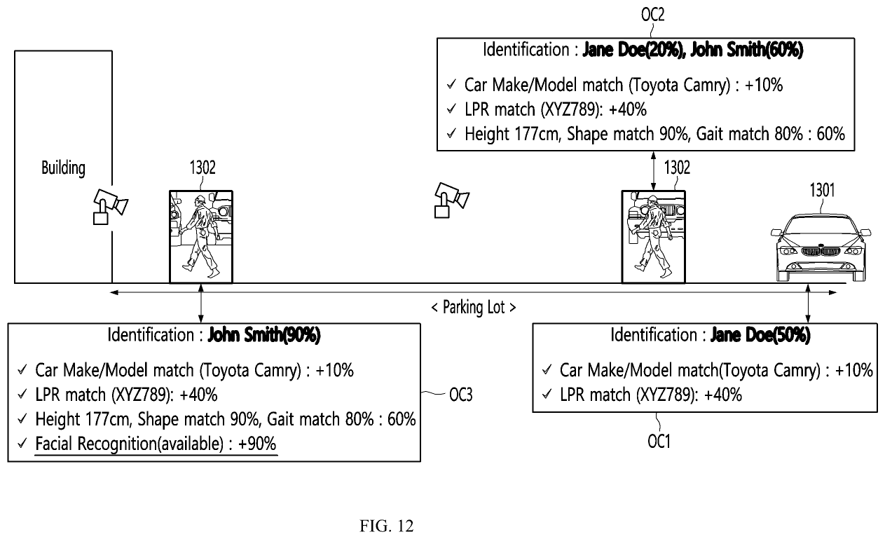

Referring to FIG. 12, in the initial stage (OC1), a vehicle (1301) detected is a Toyota Camry with license plate XYZ789, which is registered under Jane Doe. Thus, the initial identification probability recognizes Jane Doe with a probability of 50%.

In the intermediate stage (OC2), as the person (1302) exits the vehicle, the processor may analyze the physical characteristics and gait patterns, which partially match with John Smith's data. As a result, the identification probabilities are updated, with 20% probability as Jane Doe and 60% probability as John Smith.

In the final stage (OC3), as facial recognition is performed at the building entrance, the probability associated with Jane Doe decreases, and John Smith's facial recognition match increases the final probability. This process demonstrates how initial misidentification of the object as Jane Doe may be corrected through additional identification variables, ultimately confirming the object as John Smith with a high probability, thereby granting proper access.

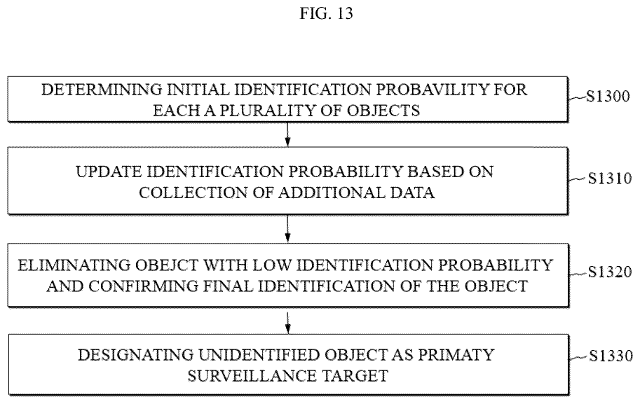

FIG. 13 is a flowchart of a virtual access control method through image analysis according to another embodiment of the present disclosure. Referring to FIG. 13, the processor may determine initial identification probabilities to each of a plurality of objects (S1300). The initial probabilities may be based on early data collected, such as vehicle information and physical characteristics, when the objects are detected in the parking lot or external areas. Since the available data at this stage is limited, the initial probabilities may have low reliability.

The processor may update the identification probabilities through collection of additional data (S1310). As the objects move, additional data such as gait patterns, behavioral patterns, and physical characteristics may be collected, and the identification probabilities may be adjusted dynamically based on the weights assigned to respective identification variables. The identification probabilities may either increase or decrease depending on the newly collected data.

The processor may eliminate an object with a low identification probability and confirm a final identity of an object (S1320). Objects that fail to meet a probability threshold may be classified as unidentified and excluded from further tracking. The processor may then designate the unidentified object as a primary surveillance target (S1330) and trigger an alert to allow the security administrator to conduct further verification.

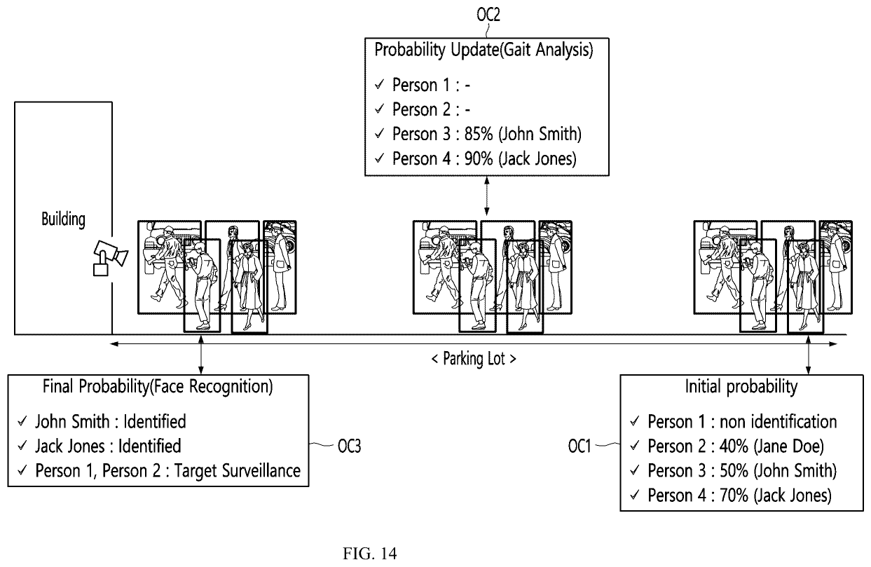

FIG. 14 illustrates an example of reducing identification targets among multiple objects based on identification probabilities according to an embodiment of the present disclosure.

According to an embodiment, in the initial stage (OC1), Person 2 is identified with a 40% probability as Jane Doe, Person 3 with a 50% probability as John Smith, and Person 4 with a 70% probability as Jack Jones, while Person 1 remains unidentified. At this stage, Person 1 may be excluded from identification, and Persons 3 and 4 may have relatively high probabilities, indicating a higher likelihood of correct identification.

In the intermediate stage (OC2), additional gait analysis data may be collected, leading to updated probabilities for each object. Person 3 is now identified with an 85% probability as John Smith, and Person 4 with a 90% probability as Jack Jones. However, Person 1 remains unidentified, and the probability determined for Person 2 decreases, causing Person 2 to be reclassified as an unidentified object. As a result, the system may narrow the focus, allowing the security administrator to classify Persons 1 and 2 as potential risks and prioritize their management before they reach the building entrance.

According to an embodiment of the present disclosure, it is possible to enhance security by combining various identification variables, such as vehicle information and physical characteristics of the object (person), to identify objects even in situations where facial recognition is not feasible.

Additionally, according to an embodiment of the present disclosure, it is possible to provide an early response by performing object identification and probability-based risk analysis from a certain distance before the object approaches the building.

Furthermore, according to an embodiment of the present disclosure, weights assigned to each identification variable may be dynamically adjusted based on real-time data collection, thereby continuously improving the accuracy of object identification for access control.

Moreover, according to an embodiment of the present disclosure, the system may classify reliable and unreliable objects, allowing security administrators to focus solely on potential threats and achieve efficient resource management.

In addition, according to an embodiment of the present disclosure, by integrating with existing access control systems and combining automatic learning capabilities with facial recognition and entry deployment systems, continuous improvement in identification performance may be achieved.

Effects of the present disclosure are not limited to the aforementioned effects, and other effects not mentioned may be clearly understood by those skilled in the art from the description above.

The present disclosure may be integrated with one or more of the surveillance cameras, autonomous vehicles, user terminals, and servers. The present disclosure may be used in association with artificial intelligence (AI) modules, robots, augmented reality (AR) devices, virtual reality (VR) devices, and devices related to 5G services, thereby expanding its application to various smart environments and security systems.

For better understanding of the present disclosure, reference numerals have been provided in the example embodiments depicted in the drawings, and specific terms have been used to describe the embodiments. However, the present disclosure is not limited by these specific terms and includes all components that may be commonly considered by those skilled in the art.

The present disclosure may be represented by functional block configurations and various processing steps. These functional blocks may be implemented using various hardware and/or software configurations capable of executing specific functions. For example, the present disclosure may employ direct circuit configurations such as memory, processing units, logic, and lookup tables, which execute various functions under the control of one or more microprocessors or other control devices. Similarly, components of the present disclosure may be implemented using programming or scripting languages such as C, C++, Java, and assembler, which may represent algorithms, data structures, processes, routines, or other programming constructs.

The functional aspects of the present disclosure may be implemented as algorithms executed by one or more processors. Additionally, related art technologies may be utilized for electronic configuration, signal processing, and/or data processing. Terms like “mechanism,” “element,” “means,” and “configuration” are used broadly and are not limited to mechanical or physical constructs. These terms may include a set of software routines associated with a processor.

The specific implementations described herein are merely examples and do not limit the scope of the present disclosure. For conciseness, descriptions of related art electronic components, control systems, software, and other functional aspects of such systems may be omitted. The connections or connecting elements shown in the drawings represent functional and/or physical or circuit connections, which may vary or include additional connections in actual implementations.

Unless explicitly stated as “essential” or “critical,” the components mentioned in the present disclosure may not be strictly necessary for the application of the disclosure. The use of terms like “the” or similar directive terms in the specification (particularly in the claims) may refer to both singular and plural forms. Where a range is described, the range includes individual values within the range, and the disclosure encompasses applications using those individual values, as if each were explicitly stated.

Unless explicitly stated otherwise or indicated by the order of description, the steps constituting the method of the present disclosure may be performed in any suitable order. The disclosure is not necessarily limited to the sequential order of steps as described.

What is claimed is:

1. A virtual access control method for controlling an access to a specific area, comprising:
obtaining an image capturing an object approaching the specific area;
analyzing the image to extract a plurality of identification variables;
determining an identification probability of the object for each of the extracted plurality of identification variables by comparing the extracted plurality of identification variables with personal information, stored in a database, of objects authorized to access the specific area; and
providing an identification result of the object based on the identification probability.

2. The virtual access control method of claim 1, wherein the analyzing the image to extract the plurality of identification variables is performed based on a determination that object recognition is not possible using at least one of face recognition or biometric recognition via the obtained image.

3. The virtual access control method of claim 1, wherein the obtaining the image comprises obtaining the image using a camera installed in the specific area, which is regularly or periodically accessed by the objects authorized to access the specific area.

4. The virtual access control method of claim 1, wherein the determining the identification probability comprises:
applying different weights to different identification variables; and
determining the identification probability based on the weights.

5. The virtual access control method of claim 4, further comprising:
obtaining a first object identification result based on the determined identification probability as the object approaches the specific area, and obtaining a second object identification result based on at least one of facial recognition or biometric information recognition as the object further approaches the specific area; and
adaptively adjusting weights of identification variables to be applied in a next first object identification result, based on comparison between the first object identification result and the second object identification result.

6. The virtual access control method of claim 1, wherein the plurality of identification variables comprise one or more of facial recognition information, vehicle information, a physical characteristic, a gait pattern, and schedule information.

7. The virtual access control method of claim 6, wherein the determining the identification probability comprises:
sequentially comparing each of the plurality of identification variables with the personal information stored in the database; and
determining a probability score for each of the plurality of identification variables, and
wherein the probability score of each identification variable dynamically changes as the object approaches the specific area.

8. The virtual access control method of claim 1, wherein the identification result comprises one or more of identification information of the object, a probability score indicating a likelihood of the object being identified, and affiliation information of the object with the specific area.

9. The virtual access control method of claim 8, further comprising:
controlling to output a warning alarm, based on the probability score indicating the likelihood of the object being identified is below a predetermined threshold.

10. The virtual access control method of claim 1, further comprising:
controlling the obtained image to be displayed on a display of an image management device, and
overlaying, on the displayed image, the identification probability determined for the plurality of identification variables and the identification result of the object.

11. A virtual access control device using image analysis, comprising:
a memory in which at least one program is recorded; and
at least one processor configured to execute the at least one program,
wherein the at least one program when executed by the at least one processor is configured to cause the at least one processor to:
receive an image capturing an object approaching a specific area and analyze the image to extract a plurality of identification variables;
determine an identification probability of the object for each of the extracted plurality of identification variables by comparing the extracted plurality of identification variables with personal information, stored in a database, of objects authorized to access the specific area; and
provide an identification result of the object based on the identification probability.

12. The virtual access control device of claim 11, wherein the at least one processor is caused to perform analyzing the image to extract the plurality of identification variables based on a determination that object recognition through at least one of facial recognition or biometric information recognition is not possible via the obtained image.

13. The virtual access control device of claim 11, wherein the at least one processor is caused to obtain the image using a camera installed in the specific area which is regularly or periodically accessed by the objects authorized to access the specific area.

14. The virtual access control device of claim 13, wherein the at least one processor is further caused to:
sequentially compare each of the plurality of identification variables with the personal information stored in the database; and
determine a probability score for each of the plurality of identification variables, and
wherein the probability score of each identification variable dynamically changes as the object approaches the specific area.

15. The virtual access control device of claim 11, wherein the at least one program is further configured to cause the at least one processor to determine the identification probability by applying different weights to different identification variables, and determining the identification probability based on the weights.

16. The virtual access control device of claim 15, wherein the at least one program is further configured to cause the at least one processor to:
obtain a first object identification result based on the determined identification probability as the object approaches the specific area, and obtain a second object identification result based on at least one of facial recognition or biometric information recognition as the object further approaches the specific area; and
adaptively adjust weights of identification variables to be applied in a next first object identification result, based on comparison between the first object identification result and the second object identification result.

17. The virtual access control device of claim 11, wherein the plurality of identification variables comprise one or more of facial recognition information, vehicle information, a physical characteristic, a gait pattern, and schedule information.

18. The virtual access control device of claim 11, wherein the identification result comprises one or more of identification information of the object, a probability score indicating a likelihood of the object being identified, and affiliation information of the object with the specific area.

19. The virtual access control device of claim 18, wherein the at least one program is further configured to cause the at least one processor to:
control to output a warning alarm, based on the probability score indicating the likelihood of the object being identified is below a predetermined threshold.

20. The virtual access control device of claim 11, wherein the at least one program is further configured to cause the at least one processor to:
control the obtained image to be displayed on a display of an image management device; and
overlay, on the displayed image, the identification probability determined for the plurality of identification variables and the identification result of the object.
